(19) United States
(12) Patent Application Publication
(10) Pub. No.: US 2022/0145501 A1
(43) Pub. Date: May 12, 2022

(54) Underwear, and System and Method of Producing Underwear

(71) Applicant: Delta Galil Industries Ltd., Caesarea (IL)

(72) Inventors: Suzanna Haratz, Karmiel (IL); Ester Ben Moshe, Kiryat Yam (IL); Tali Attias, Kiryat Tivon (IL); Eli Almog, Zurit (IL)

(21) Appl. No.: 17/523,040

(22) Filed: Nov. 10, 2021

Related U.S. Application Data
(60) Provisional application No. 63/112,677, filed on Nov. 12, 2020.

(51) Int. Cl. D04B 1/24; A41B 9/04; A41B 9/14

(52) U.S. Cl. CPC D04B 1/243; D10B 2501/02; A41B 9/14; A41B 9/04

(57) ABSTRACT

Underwear or undergarment, particularly for a female wearer. A seamless knitted-yarn tubular blank is produced and is rotated; a front-side partial-cut is introduced, and a rear-side partial-cut is introduced; thereby forming two leg openings and one waist opening. Optionally, an elastic-free lace band is seamlessly glued or bonded or attached to the region that borders the waist opening. The underwear can be manufactured from a single, seamless, tubular knitted-yarn blank, without leaving or removing or discarding any fabric residues.

### CROSS-REFERENCE TO RELATED APPLICATIONS

This application claims benefit and priority from U.S. 63/112,677, filed on Nov. 12, 2020, which is hereby incorporated by reference in its entirety.

### FIELD

Some embodiments are related to the field of clothing.

### BACKGROUND

Clothing articles and clothes are typically formed of textile material and are worn on the body. Clothes are worn for various purposes, for example, to keep the human body warm in a cold weather, to protect the human body from rough surfaces or insects or plants, to provide a hygienic barrier between the human body and the environment, to protect the human body from ultraviolet radiation, to cover genitals, for social reasons or as fashion, or the like.

### SUMMARY

Some embodiments provide underwear and undergarments, particularly for a female wearer; as well as methods and systems for producing such underwear and undergarments.

For example, a seamless knitted-yarn tubular blank is produced and is then rotated; a front-side partial-cut is introduced, and a rear-side partial-cut is introduced; thereby forming two leg openings and one waist opening. Optionally, an elastic-free lace band is seamlessly glued or bonded or attached to the region that borders the waist opening. The underwear can be manufactured from a single, seamless, tubular knitted-yarn blank, without leaving or removing or discarding any fabric residues.

Some embodiments may provide other and/or additional benefits and/or advantages.

### BRIEF DESCRIPTION OF THE DRAWINGS

FIG. 1A is a schematic illustration of a tube-shaped fabric, in accordance with some demonstrative embodiments.

FIG. 1B is a schematic illustration of another tube-shaped fabric, in accordance with some demonstrative embodiments.

FIG. 1C is a schematic illustration of a front side of a tube-shaped fabric, in accordance with some demonstrative embodiments.

FIG. 1D is a schematic illustration of a back side or a rear side of a tube-shaped fabric, in accordance with some demonstrative embodiments.

FIG. 1E is a schematic illustration of a clothing article, in accordance with some demonstrative embodiments.

FIG. 1F is an illustration of a front side of the final clothing article (e.g., underwear or undergarment) as produced in accordance with some demonstrative embodiments.

FIG. 1G is an illustration of a back side or rear side of the final clothing article (e.g., underwear or undergarment) as produced in accordance with some demonstrative embodiments.

FIG. 2 is an illustration of a clothing article (e.g., underwear or undergarment) as produced in accordance with some demonstrative embodiments.

FIG. 3 is a schematic illustration of a face mask, in accordance with some demonstrative embodiments.

### DETAILED DESCRIPTION OF SOME DEMONSTRATIVE EMBODIMENTS

Some embodiments provide underwear and undergarments, particularly for female wearers; as well as methods and systems for producing or making or manufacturing such underwear and undergarments.

The Applicants have realized that a conventional system or method for producing underwear, typically requires 6 (or more) separate production steps: (1) knitting or producing a tubular fabric; (2) manual cutting by scissors two leg openings; (3) manual cutting by scissors a contour for a gusset component; (4) attaching a gusset component; (5) adding elastics to the leg openings; (6) cutting and/or removing excess yarn or fabric.

In contrast, some embodiments provide a shortened and efficient tri-step method or triple-step method for producing underwear, and a system able to produce underwear in three steps or by using only three production unit or production steps: (1) knitting or producing a tubular fabric; (2) cutting a top section of the tubular fabric; (3) adding or sewing or connecting a waistband component.

Furthermore, the tubular fabric component or the “tubular blank” or the “tubular fabric template” of some embodiments may be narrower than a conventional tubular fabric (or a conventional tubular blank, or a conventional tubular fabric template) for underwear; and the narrower fabric tube (or tubular fabric or tubular blank) enables, for example, a transition from a narrow seam to a wide seam (e.g., along the same seam), thereby enabling to produce the particular structure of the gusset, and/or further providing the required width to cover the buttocks of the wearer. In some embodiments, the tubular fabric or the tubular “blank” may be symmetrical right-to-left, but is non-symmetrical front-to-back: for example, the front side of the tube or the tubular blank may be narrower, while the rear side or the back side of the tube or the tubular blank may be wider.

In some embodiments, the underwear may be produced using Seamless technology, in which fabric components are produced or connected to each other without seams and/or by using seam-less connection(s), or may be produced as a monolithic single-piece fabric or tube or tubular element or product; for example, without the need to manufacture separate pieces of fabric (or separate garment-regions or garment-components) and to then connect them using seams. This further contributes to saving(s) in fabric or yarns or raw material(s), and/or produces a smaller amount of unused fabric for disposal; and/or even produces (in some implementations) no unused fabric at all. In some, or in most, of the implementations in accordance with some embodiments, the manufacturing process may not produce any unused fabric, and/or any unused fabric-portions or garment-portions or garment-components that need to be disposed of or thrown away; and in some, or in few, of the implementations, a very small amount of unused fabric-portion remains from the manufacturing process (e.g., less than 10 or 5 or 3 or 2 percent of the entire amount of fabric or yarns used).

In some embodiments, the tubular fabric component or the tubular blank or the tubular fabric template may be formed of one or more suitable yarns; and/or the leg openings, or the area or region of each leg opening, may optionally be produced from yarn(s) that are different from those that cover the buttocks or the genitals of the wearer; in order to achieve a particular functional advantage, for example, in order to provide increased support and/or increased tightness to the buttocks area, and/or in order to provide a more comfortable feeling and/or less friction to the thighs area and/or at the body-regions that are adjacent to the let openings of the underwear.

For demonstrative purposes, the three-step production process of some embodiments, is demonstrated herein over several drawings that break down the process into its finer details.

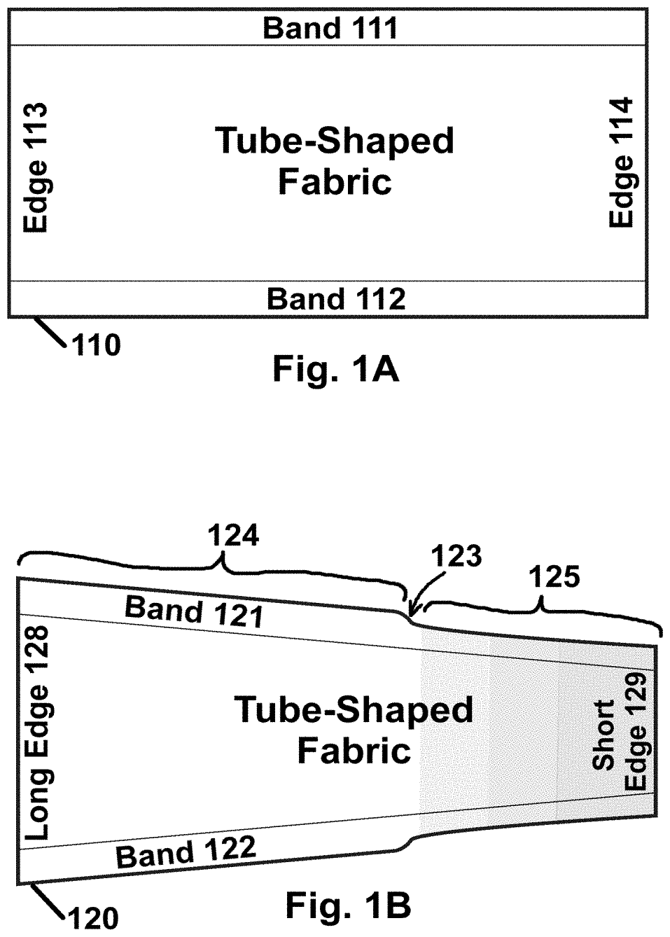

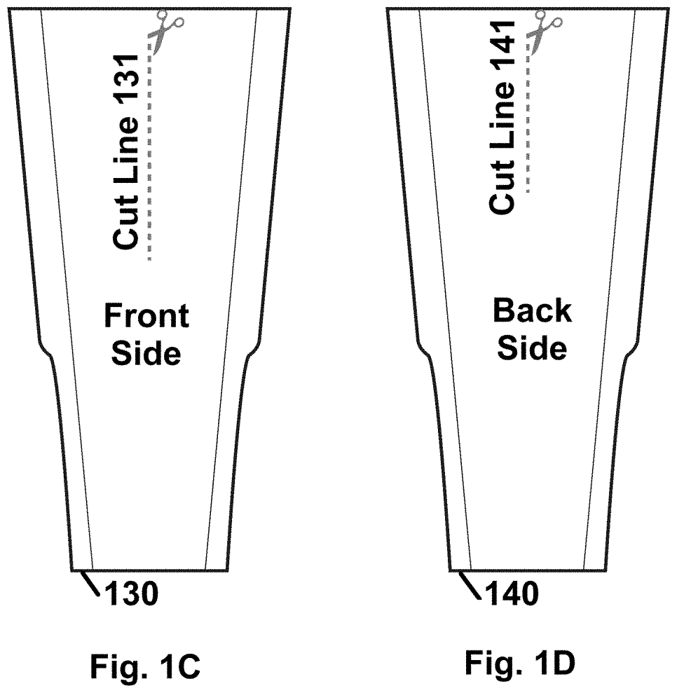

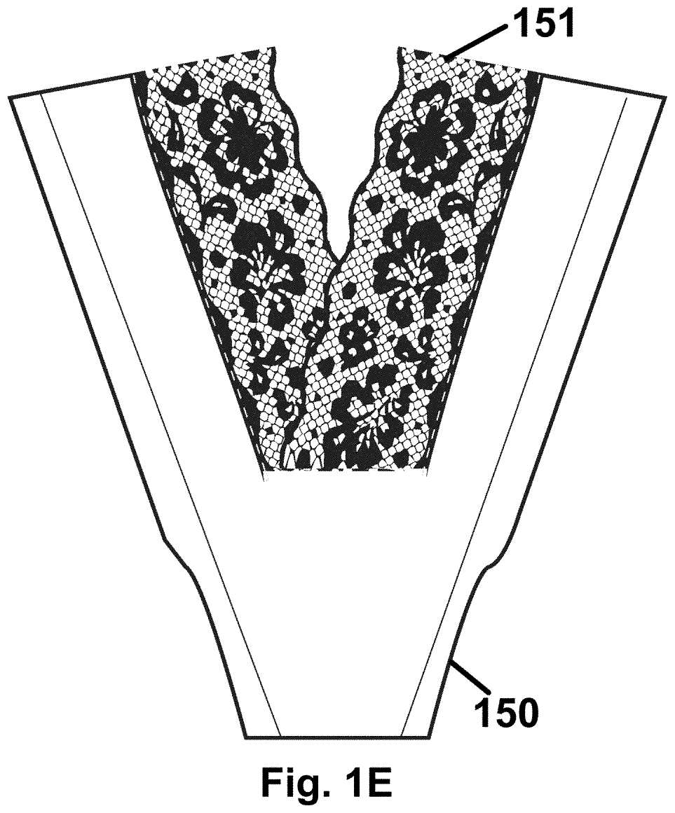

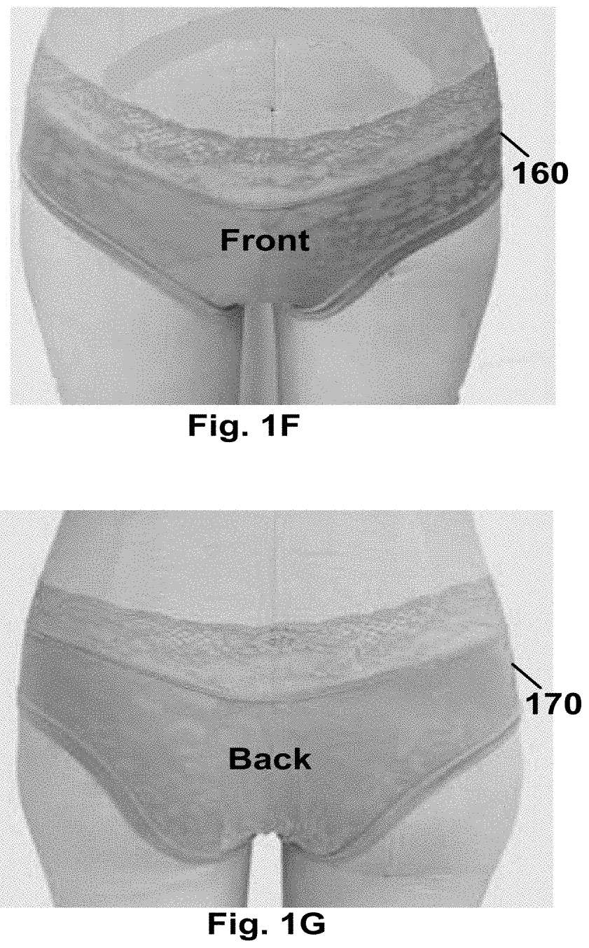

FIG. 1A is a schematic illustration of a tube-shaped fabric 110, in accordance with some demonstrative embodiments. It may be produced by a tubular knitting machine, or by a knitting machine capable of (or configured to) produce a tubular fabric or a tubular blank or a tubular fabric template, similar to a tubular fabric utilized for a sock.

The produced tube-shaped fabric 110 may comprise two bands 111 and 112, at opposite sides of the tube. For example, the edge that is marked as Band 111 is actually a top circular band of a cylindrical tube; and the opposite edge that is marked as Band 112 is actually a bottom circular band of the cylindrical tube. Edge 113 and edge 114 are straight edges of the cylindrical tube, or they are side-walls or side-panels or side-edges of the cylindrical tube.

FIG. 1B is a schematic illustration of a tube-shaped fabric 120, in accordance with some demonstrative embodiments. It may be produced by a tubular knitting machine, or by a knitting machine capable of (or configured to) produce a tubular fabric or a tubular blank or a tubular fabric template, similar to a tubular fabric utilized for a sock. It may be produced from scratch; or it may be produced by converting or modifying the tube-shaped fabric 110 of FIG. 1A.

The produced tube-shaped fabric 120 may comprise two bands 121 and 122, at opposite sides of the tube. For example, the edge that is marked as Band 121 is actually a top circular band of a cylindrical tube; and the opposite edge that is marked as Band 122 is actually a bottom circular band of the cylindrical tube. Edge 128 and edge 129 are straight edges of the cylindrical tube, or they are side-walls or side-panels or side-edges of the cylindrical tube. Particularly, one of the edges or sides (edge 128) is long or longer; whereas the opposite edge or side (edge 129) is short or shorter.

Optionally, the width of each Band (121, 122) is non-fixed or non-constant; for example, in Band 121, there is a first region 124 having a first width, and there is a second region 125 having a second (reduced) width; and the two regions (123, 124) may be connected via a small portion 123 having a gradually-decreasing width that gradually changes the width of the band from the width of region 123 to the reduced-width region 124. Optionally, the gradual reduction in band width may be achieved by cutting an original fixed-width band (e.g., similar to band 111) with a knife or blade or scissors or other cutting tool. Band 122 may have a changing-width structure similar or identical to band 121.

FIG. 1C is a schematic illustration of a front side 130 of a tube-shaped fabric, in accordance with some demonstrative embodiments. FIG. 1D is a schematic illustration of a back side 140 of a tube-shaped fabric, in accordance with some demonstrative embodiments. Front side 130 and Back side 140 are two opposite sides of the same item, which may be the tube-shaped fabric 120 discussed above; such as, rotated by 90 degrees relative to its position shown in FIG. 1B.

As indicated in FIG. 1C, the front side 130 of the article is cut, with a knife or blade or scissors or other cutting tool, along a front-side cut line 131 (e.g., reaching approximately 15 or 20 or 25 centimeters inwardly). Similarly, as indicated in FIG. 1D, the back side 140 of the article is cut, with a knife or blade or scissors or other cutting tool, along a back-side cut line 141 (e.g., reaching approximately 15 or 20 or 25 centimeters inwardly).

In some embodiments, the length of cut line 131 is identical to the length of cut line 141. In other embodiments, the front cut-line 131 is longer (e.g., by 10 or 20 or 25 or 30 percent; or by 10 to 30 percent; or by 10 to 40 percent; or by 10 to 50 percent) than the back-side cut line 141. In yet other embodiments, the front cut-line 131 is shorter (e.g., by 10 or 20 or 25 or 30 percent; or by 10 to 30 percent; or by 10 to 40 percent; or by 10 to 50 percent) than the back-side cut line 141.

FIG. 1E is a schematic illustration of an article 150, in accordance with some demonstrative embodiments. It may be produced by taking the item that was made in the previous steps (e.g., having the front side 130 and the back side 140), and by separating-apart (e.g., distancing from each other, or making slanted as a V shape) the two sides of the cut lines (131, 141), and by adding a Lace Band 151 (or a lingerie band) at the two edges created by each cut line (131, 141).

The lace band 151 may be added, for example, by gluing, taping, bonding, knitting, or other suitable connecting method which may optionally involve or include the application of heat during the connecting process (e.g., heat gluing, heat bonding, heat taping, heat-press gluing, heat-press bonding, heat-press taping, a heat process or a heat-and-press process that also includes ultrasonic vibrations, or the like).

The Lace Band 151 is only a non-limiting example of some embodiments. For example, in some embodiments, instead of Lace Band 151, or in addition to it, other types of production treatment(s) or garment-component additions may be used or may be added or may be applied; for example, addition or connection or attachment of a knitted belt or belt-like item or belt-like fabric-element or a knitted band (e.g., a fabric band and/or an elastic band), a bonding process that bonds or glues a band or a fabric band or an elastic band, a sewing process that sews an elastic belt or an elastic band or a fabric belt or a fabric belt, a cut-free process which adds or connects other fabric instead of the lace band 151 or in addition to it, an ultrasonic cutting or ultrasonic welding process that adds a fabric band and/or an elastic band by utilizing ultrasonic vibrations in combination with other connection method (e.g., bonding, gluing, taping, heat-press), attachment or sewing or bonding of an elastic band instead of the lace band 151 or in addition to the lace band 151; or a combination of two or more of said processes or features. In some embodiments, the above-listed methods or operations, or one of them, or some of them, or a combination of them, may be applied to the addition of the Lace Band 151; or may be utilized or performed instead of adding the Lace band 151; and/or may be applied to the edges of the article that are apertures to the legs or the hips of the wearer.

Reference is made to FIG. 1F, which is an illustration of a front-side 160 of the final clothing article (e.g., underwear or undergarment) as produced in accordance with some demonstrative embodiments; and also to FIG. 1G, which is an illustration of a back-side 170 or rear side of the final clothing article (e.g., underwear or undergarment) as produced in accordance with some demonstrative embodiments. In some embodiments, the undergarment may be implemented or structured as underpants, as panties, as a lingerie item, as a thong, or the like.

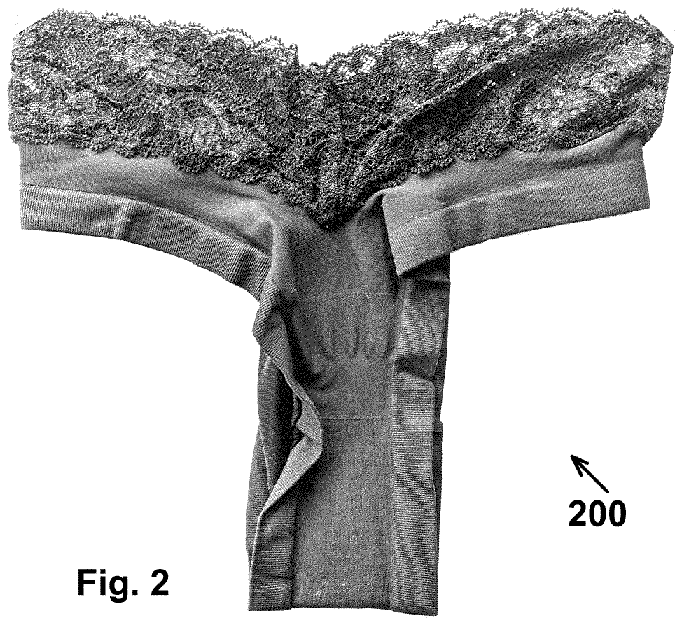

Reference is made to FIG. 2, which is an illustration of a clothing article 200 (e.g., underwear or undergarment) as produced in accordance with some demonstrative embodiments. The waist area or the waist region, which surrounds the waists of the human wearer, ends with a lace band; it enables the clothing article to comfortably sit on the waists of the wearer, or to comfortably hold onto or hug around the waists of the wearer, in a non-pressing manner or a non-pressurizing manner; without elastically pushing or pressing into the waists or the body, and/or without compressing or tightening the waists of the wearer. Additionally, in some embodiments, the manufacturing process of this article produces virtually no residues or yarn and/or fabric, or no residual yarn(s) or fabric(s); since the knitted tubular blank or the knitted tubular cylinder is cut along the two cut-lines mentioned above, thereby forming the opening for the waists area of the wearer, without cutting-away or removing or discarding any fabric-portion or any yarn(s) or any knitted yarn(s). In some embodiments, the leg openings of the article are formed via knitting of the yarn, without the need to add or to create or to use a seam and/or an elastic band at a leg opening or at the edge of a leg opening. Similarly, in some embodiments, the gusset area of the article, or the article that covers (partially or entirely) the genitalia and/or the crotch area of the wearer, is a seam-less garment-regions, and is formed by and from knitted yarn(s), without the need to add an elastic band or an elastic element in that garment-region or in order to define or to structure that garment-region.

The underwear or garment of some embodiments may be formed of one or more suitable materials; for example, cotton, polyester, natural yarn(s), synthetic yarn(s), a mixture or a blend of natural and/or synthetic yarns, 3D-printed material(s) or 3D-printed yarns, a thermoplastic polyurethane (TPU) material or yarn (e.g., such as “Lubrizol X4zol (TM)-J”, or other elastomeric monofilament), Spandex, Lycra, Elastane, a polyether-polyurea copolymer material or yarn or fabric, and/or a combination of two or more of the above yarns or materials.

In some embodiments, the edges of the apertures for the legs or hips, in the underwear or garment of the present invention, end with non-pressing or non-pressurizing knitted zones which were the original bands (121, 122) of the tube-shaped fabric 120; without additional knitting or seams or elastic components; thereby providing seam-less edges to the apertures for the legs or hips of the wearer.

In some embodiments, the edge of the aperture or the opening for the waists of the wearer, in the underwear or garment or clothing article, may end with the Lace Band 151 or with other type of non-pressing or non-pressurizing knitted zones or knitted band or knitted fabric-element; without additional knitting or seams or elastic components; thereby providing a seam-less edge to the aperture or to the opening for the waists area of the wearer, and/or enabling the waists area of the underwear to comfortably sit or rest on the waist area of the human wearer without pressing or pressurizing that body region.

The underwear or garment of some embodiments may thus be fundamentally different from conventional types of underwear; in which, for example, the crotch area or the crotch-covering area or the gusset area or the genitalia-covering comprise(s) a seam or a knitting line that extends (e.g., horizontally or vertically or diagonally) along that area or across the area or within the garment-region (such as, perpendicular to the ground when the underwear is worn, extending horizontally from right to left, or from east to west); and/or which have knitting lines and/or seams that define or that structure the edges of the apertures (or openings) for the hips or legs; and/or which have knitting lines and/or seams that define the edges of the aperture for the waists of the human wearer.

Some embodiments may comprise, for example, an undergarment (e.g., underwear, panties, thong, lingerie items, or the like), comprising: (a) a right-side aperture, which is an aperture for the right leg or right hip of the wearer; (b) a left-side aperture, which is an aperture for the left leg or left hip of the wearer; (c) a top-side aperture, which is an aperture for the waist area of the wearer; (d) a front-side fabric region, which is adapted to cover at least a portion of the front side of the genitalia of the wearer; (e) a rear-side fabric region, which is adapted to cover at least a portion of the buttocks of the wearer and/or the anus of the wearer. The front-side fabric region and the rear-side fabric region are a single continuous panel of a single cylindrical tube. The right-side aperture and the left-side aperture are two generally-circular or generally-oval apertures of that same single cylindrical tube. The top-side aperture for the waist area comprises a lace band, or other knitted belt component or knitted band component, which may be elastic free or which may lack an elastic band; that is connected (e.g., via a glue-based connection, via a tape-based connection, via a bonded connection, via a taped connection, via a knitted connection mechanism, via a knitted connection mechanism, via an ultrasonic-based connection mechanism, via a seam-less connection mechanism, or the like) to: (i) a front right-side zone located to the right of a front-side cut-line of the front-side fabric region; and also to (ii) a rear left-side zone located to the left of that front-side cut-line of the front-side fabric region; and also (iii) a rear right-side zone located to the right of a rear-side cut-line of the rear-side fabric region; and also (iv) a rear left-side zone located to the left of the rear-side cut-line of the rear-side fabric region.

In some embodiments, the knitted underwear or undergarment may be seamless. In other embodiments, optionally, it may not necessarily be entirely seamless; and one or more seams may be added or applied or utilized in order to achieve or to improve a particular functionality and/or three-dimensional structure of the underwear or undergarment; for example, in order to assist in connected the waist-band or the lace-band to the knitted fabric, and/or in order to assist in closing or securing a loop or a circular border of a garment opening (e.g., a leg opening, a waist opening).

Some embodiments may provide an underwear (or an undergarment) for a human wearer, comprising: (a) a seamless knitted-yarn right-side aperture structure, having a right-side aperture for a right leg or a right hip of the human wearer, wherein the right-side aperture is defined by a right-side seam-less knitted-yarn fabric structure that seamlessly surrounds and defines the right-side aperture and that is elastic-free; (b) a seamless knitted-yarn left-side aperture structure, having a left-side aperture for a left leg or a left hip of the human wearer, wherein the left-side aperture is defined by a left-side seam-less knitted-yarn fabric structure that seamlessly surrounds and defines the left-side aperture and that is elastic-free; (c) a seamless knitted-yarn top-side aperture structure, having a top-side aperture for waists of the human wearer, wherein the top-side aperture is defined by a top-side seam-less knitted-yarn fabric structure that seamlessly surrounds and defines the top-side aperture and that is elastic-free; (d) a seamless knitted-yarn front-side fabric-region, which is adapted to cover at least a portion of a front side of genitalia of the human wearer and that is elastic-free; (e) a seamless knitted-yarn rear-side fabric-region, which is adapted to cover at least a portion of buttocks and an anus of the human wearer and that is elastic-free; (f) a seamless knitted-yarn gusset fabric-region, which is adapted to cover at least a portion of a crotch the human wearer, and which is elastic-free, and which is seamlessly connected to the seamless knitted-yarn front-side fabric-region, and which is seamlessly connected to the seamless knitted-yarn rear-side fabric-region. In some embodiments, (i) the seamless knitted-yarn left-side aperture structure, and (ii) the seamless knitted-yarn left-side aperture structure, and (iii) the seamless knitted-yarn top-side aperture structure, and (iv) the seamless knitted-yarn front-side fabric-region, and (v) the seamless knitted-yarn rear-side fabric-region, and (vi) the seamless knitted-yarn gusset fabric-region, are all a single continuous knitted-yarn seam-less fabric panel of a single knitted tubular fabric blank.

In some embodiments, the seamless knitted-yarn top-side aperture structure comprises an elastic-free lace band, that is adapted to encircle the waists of the human wearer and to sit on the waist of the human wearer without elastically pressing the waists of the human wearer.

In some embodiments, the seamless knitted-yarn top-side aperture structure comprises an elastic-free lace band that is seamlessly glued or bonded to knitted-yarn fabric of the seamless knitted-yarn top-side aperture structure.

In some embodiments, the seamless knitted-yarn top-side aperture structure is a seam-less knitted-yarn continuation of a right-side fabric-region that surrounds and defines the seamless knitted-yarn right-side aperture structure; and also, wherein the seamless knitted-yarn top-side aperture structure is a seam-less knitted-yarn continuation of a left-side fabric-region that surrounds and defines the seamless knitted-yarn left-side aperture structure.

In some embodiments, the seamless knitted-yarn right-side aperture structure is defined and structured by a front-side partial-cut and by a rear-side partial-cut; wherein the seamless knitted-yarn right-side aperture structure is defined and structured by said front-side partial-cut and by said rear-side partial-cut; wherein the front-side partial-cut is a cut line that penetrates, from a first knitted-yarn edge of said single knitted tubular fabric blank, inwardly across a front-side ply of knitted fabric towards a second, opposite, knitted-yarn edge of said single knitted tubular fabric blank, without reaching said second knitted-yarn edge of said single knitted tubular fabric blank; wherein the rear-side partial-cut is another cut line that penetrates, from the first knitted-yarn edge of said single knitted tubular fabric blank, inwardly across a rear-side ply of fabric towards a second, opposite, knitted-yarn edge of said single knitted tubular fabric blank, without reaching said second knitted-yarn edge of said single knitted tubular fabric blank.

In some embodiments, a length of the front-side partial-cut is equal to a length of the rear-side partial-cut.

In some embodiments, a length of the front-side partial-cut is 10 to 40 percent smaller than a length of the rear-side partial-cut.

In some embodiments, a length of the rear-side partial-cut is 10 to 40 percent smaller than a length of the front-side partial-cut.

In some embodiments, an entirety of said underwear consists exclusively of a single, seam-less, elastic-free, tubular knitted-yarn fabric cylinder, having a front-side cut and a rear-side cut that together define two leg openings.

In some embodiments, an entirety of said underwear consists exclusively of: (i) a single, seam-less, elastic-free, tubular knitted-yarn fabric cylinder, having a front-side cut and a rear-side cut that together define two leg openings, and (ii) a lace band that is seamlessly attached to a knitted-yarn waist-region of said underwear, via a seam-less connection.

In some embodiments, a right-leg (or right-hip, or right-thigh) covering portion of said underwear, is a first closed band of said single knitted tubular fabric blank; wherein a left-leg (or right-hip, or right-thigh) covering portion of said underwear, is a second, opposite, closed band of said single knitted tubular fabric blank.

In some embodiments, the right-leg (or right-hip, or right-thigh) covering portion of said underwear has a gradually-changing width that directly corresponds to a gradually-changing width of the first closed band of said single knitted tubular fabric blank; wherein the left-leg (or right-hip, or right-thigh) covering portion of said underwear has a gradually-changing width that directly corresponds to a gradually-changing width of the second closed band of said single knitted tubular fabric blank.

In some embodiments, (i) the seamless knitted-yarn right-side aperture structure, and (ii) the seamless knitted-yarn top-side aperture structure, and (iii) the seamless knitted-yarn front-side fabric-region, and (iv) the seamless knitted-yarn rear-side fabric-region, and (v) the seamless knitted-yarn gusset fabric-region, are all a first knitted-yarn seam-less band of said single knitted tubular fabric blank. In some embodiments, (I) the seamless knitted-yarn left-side aperture structure, and (ii) the seamless knitted-yarn top-side aperture structure, and (iii) the seamless knitted-yarn front-side fabric-region, and (iv) the seamless knitted-yarn rear-side fabric-region, and (v) the seamless knitted-yarn gusset fabric-region, are all a second, opposite, knitted-yarn seam-less band of said single knitted tubular fabric blank.

In some embodiments, an entirety of said underwear consists exclusively of a single tubular knitted-yarn fabric cylinder, which has (I) a first seam-less circular knitted-yarn band, and (II) a second generally-parallel seam-less circular knitted-yarn band, and (III) a tubular seam-less knitted-yarn fabric that has a generally-rectangular structure when laid flat and that connects the first seam-less circular knitted-yarn band and the second seam-less circular knitted-yarn band. In some embodiments, the first seam-less circular knitted-yarn band is generally perpendicular to a ground when the underwear is worn by the human wearer; and the second seam-less circular knitted-yarn band is generally perpendicular to the ground when the underwear is worn by the human wearer.

In some embodiments, an entirety of said underwear is elastic-free, and excludes any elastic band that encircles the waists of the human wearer, and excludes any elastic band that encircles any leg opening of said underwear.

In some embodiments, said underwear is formed of at least one of: cotton, polyester, natural yarn, synthetic yarn, a blend of natural yarn and synthetic yarn.

Some embodiments provide a method comprising: manufacturing an underwear for a human wearer, by performing: (a) knitting a single, seamless, tubular, knitted-yarn blank; (b) cutting a front-side partial-cut at a front-side of the single seamless tubular knitted-yarn blank; and cutting a rear-side partial-cut at a rear-side of said single seamless tubular knitted-yarn blank; wherein the cutting of the front-side partial-cut comprises: cutting a front-side cut line that penetrates, from a first knitted-yarn edge of said single seamless knitted tubular knitted-yarn blank, inwardly across a front-side ply of knitted fabric towards a second, opposite, knitted-yarn edge of said single seamless knitted tubular knitted-yarn blank, without reaching said second knitted-yarn edge of said single seamless knitted tubular knitted-yarn blank; wherein the cutting of the rear-side partial-cut comprises: cutting a rear-side cut line that penetrates, from the first knitted-yarn edge of said single seamless knitted tubular knitted-yarn blank, inwardly across a rear-side ply of knitted fabric towards a second, opposite, knitted-yarn edge of said single seamless knitted tubular knitted-yarn blank, without reaching said second knitted-yarn edge of said single seamless knitted tubular knitted-yarn blank; (c) seamlessly attaching an elastic-free lace band to fabric regions that border said front-side cut line and said front-side cut line, to form a waist opening of said underwear. In some embodiments, the manufacturing excludes, and does not require, any cutting-out and any removal or discarding of any excess knitted fabric.

Some embodiments provide a system, which includes: a manufacturing apparatus to manufacture an underwear for a human wearer, comprising: (a) a knitting unit configured to knit a single, seamless, tubular, knitted-yarn blank; (b) a cutting unit, configured to perform a front-side partial-cut at a front-side of the single seamless tubular knitted-yarn blank; and also configured to perform rear-side partial-cut at a rear-side of said single seamless tubular knitted-yarn blank; wherein the cutting unit is configured to perform a front-side cut line that penetrates, from a first knitted-yarn edge of said single seamless knitted tubular knitted-yarn blank, inwardly across a front-side ply of knitted fabric towards a second, opposite, knitted-yarn edge of said single seamless knitted tubular knitted-yarn blank, without reaching said second knitted-yarn edge of said single seamless knitted tubular knitted-yarn blank; wherein the cutting unit is configured to perform a rear-side cut line that penetrates, from the first knitted-yarn edge of said single seamless knitted tubular knitted-yarn blank, inwardly across a rear-side ply of knitted fabric towards a second, opposite, knitted-yarn edge of said single seamless knitted tubular knitted-yarn blank, without reaching said second knitted-yarn edge of said single seamless knitted tubular knitted-yarn blank; (c) a seamless bonding unit, configured to seamlessly attach an elastic-free lace band to fabric regions that border said front-side cut line and said front-side cut line, to form a waist opening of said underwear. In some embodiments, the manufacturing apparatus is configured to manufacture said underwear without performing and without requiring any cutting-out and/or any removal and/or discarding of any excess knitted fabric.

In some embodiments, optionally, two opposing edges or contours or borders or margins, of a particular garment-region, may be bonded together or may be attached to each other, via bonding or gluing or via a heat-press connection, or via other seam-less connection, or optionally (in some implementations) via a seam; or via a suitable knitting technique; for example, in order to achieve (if needed, in some implementations) an oval or circular border or structure of a leg opening or a waist opening (e.g., after performing the cutting along the cut-line(s) as described).

Some embodiments may be utilized or modified or applied in order to produce or manufacture a garment or a fabric-based accessory or article that is not necessarily an underwear or an undergarment; for example, in order to similarly manufacture a skirt, or short pants, or short pajama pants, or lingerie items, or a garment that is not necessarily worn beneath another garment. Some embodiments may similarly be used to manufacture a mask or a face mask or a facial mask, which may be worn by a person for various purposes, including (but not limited to) for providing partial or entire protection against virus or bacteria or germs or pollution or odors or sunlight or COVID-19 or Coronavirus or other non-desired particles. For example, a tubular, seamless, knitted fabric template or blank or cylinder may be formed; and instead of structuring the final articular as underwear, the final article may be similarly structured as a face mask.

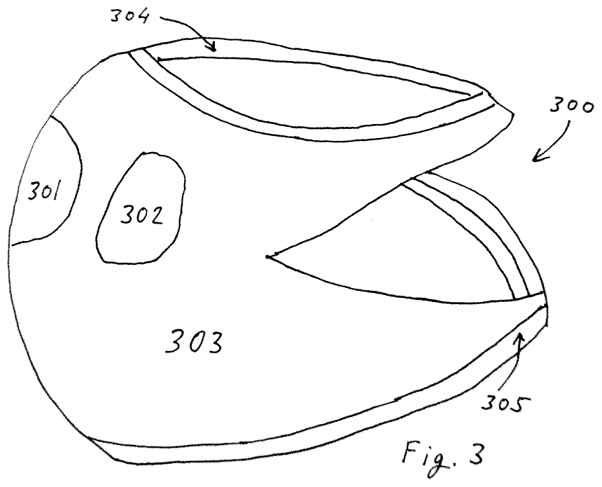

Reference is made to FIG. 3, which is a schematic illustration of a face mask 300, in accordance with some demonstrative embodiments. The body 303 or the main component of the mask 300 is formed of knitted fabric, such as, a tubular knitted structure that is then cut via the two cut-lines. The two bands of the tubular structure (bands 304 and 305) are utilized as, or are converted into, straps or head-straps that are configured to encircle the head and to allow wearing of the mask by a person.

In some embodiments, an entirety of the mask body 303 is formed of a uniform type of yarn and/or with a uniform knitting structure and/or a uniform knitting pattern. In other embodiments, optionally, one or more mask-regions, such as mask-regions 301 and 302, may be knitted using a different yarn and/or using Mesh knitting and/or using a different knit structure and/or using a different knit pattern and/or sing a different knitting technique, and/or may have small holes or small apertures or small ventilation holes to facilitate breathing through the mask and/or ventilation properties of the mask or of those mask-regions.

Some embodiments may be implemented by using a machine or an automated or semi-automatic production line, which may comprise, for example: cutting unit, welding unit, bonding unit, ultrasonic operations unit, gluing unit, conveyor belt, robotic arm, control unit, workstation; as well as suitable hardware components and/or software components, for example, processor to execute code, memory unit, storage unit, input unit (keyboard, mouse, touch-screen), output unit (screen, touch-screen), modems, transceivers or transmitters or receivers, wireless and/or wired communication links and/or transceivers or transmitters or receivers, power sources, Operating System (OS) and suitable applications, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. An underwear for a human wearer, comprising:
(a) a seamless knitted-yarn right-side aperture structure, having a right-side aperture for a right leg or a right hip of the human wearer, wherein the right-side aperture is defined by a right-side seam-less knitted-yarn fabric structure that seamlessly surrounds and defines the right-side aperture and that is elastic-free;
(b) a seamless knitted-yarn left-side aperture structure, having a left-side aperture for a left leg or a left hip of the human wearer, wherein the left-side aperture is defined by a left-side seam-less knitted-yarn fabric structure that seamlessly surrounds and defines the left-side aperture and that is elastic-free;
(c) a seamless knitted-yarn top-side aperture structure, having a top-side aperture for waists of the human wearer, wherein the top-side aperture is defined by a top-side seam-less knitted-yarn fabric structure that seamlessly surrounds and defines the top-side aperture and that is elastic-free;
(d) a seamless knitted-yarn front-side fabric-region, which is adapted to cover at least a portion of a front side of genitalia of the human wearer and that is elastic-free;
(e) a seamless knitted-yarn rear-side fabric-region, which is adapted to cover at least a portion of buttocks and an anus of the human wearer and that is elastic-free;
(f) a seamless knitted-yarn gusset fabric-region, which is adapted to cover at least a portion of a crotch the human wearer, and which is elastic-free, and which is seamlessly connected to the seamless knitted-yarn front-side fabric-region, and which is seamlessly connected to the seamless knitted-yarn rear-side fabric-region;
wherein (i) the seamless knitted-yarn left-side aperture structure, and (ii) the seamless knitted-yarn left-side aperture structure, and (iii) the seamless knitted-yarn top-side aperture structure, and (iv) the seamless knitted-yarn front-side fabric-region, and (v) the seamless knitted-yarn rear-side fabric-region, and (vi) the seamless knitted-yarn gusset fabric-region, are all a single continuous knitted-yarn seam-less fabric panel of a single knitted tubular fabric blank.

2. The underwear of claim 1,
wherein the seamless knitted-yarn top-side aperture structure comprises an elastic-free lace band, that is adapted to encircle the waists of the human wearer and to sit on the waist of the human wearer without elastically pressing the waists of the human wearer.

3. The underwear of claim 1,
wherein the seamless knitted-yarn top-side aperture structure comprises an elastic-free lace band that is seamlessly glued or bonded to knitted-yarn fabric of the seamless knitted-yarn top-side aperture structure.

4. The underwear of claim 1,
wherein the seamless knitted-yarn top-side aperture structure is a seam-less knitted-yarn continuation of a right-side fabric-region that surrounds and defines the seamless knitted-yarn right-side aperture structure; and also,
wherein the seamless knitted-yarn top-side aperture structure is a seam-less knitted-yarn continuation of a left-side fabric-region that surrounds and defines the seamless knitted-yarn left-side aperture structure.

5. The underwear of claim 4,
wherein the seamless knitted-yarn right-side aperture structure is defined and structured by a front-side partial-cut and by a rear-side partial-cut;
wherein the seamless knitted-yarn right-side aperture structure is defined and structured by said front-side partial-cut and by said rear-side partial-cut;
wherein the front-side partial-cut is a cut line that penetrates, from a first knitted-yarn edge of said single knitted tubular fabric blank, inwardly across a front-side ply of knitted fabric towards a second, opposite, knitted-yarn edge of said single knitted tubular fabric blank, without reaching said second knitted-yarn edge of said single knitted tubular fabric blank;
wherein the rear-side partial-cut is another cut line that penetrates, from the first knitted-yarn edge of said single knitted tubular fabric blank, inwardly across a rear-side ply of fabric towards a second, opposite, knitted-yarn edge of said single knitted tubular fabric blank, without reaching said second knitted-yarn edge of said single knitted tubular fabric blank.

6. The underwear of claim 5,
wherein a length of the front-side partial-cut is equal to a length of the rear-side partial-cut.

7. The underwear of claim 5,
wherein a length of the front-side partial-cut is 10 to 40 percent smaller than a length of the rear-side partial-cut.

8. The underwear of claim 5,
wherein a length of the rear-side partial-cut is 10 to 40 percent smaller than a length of the front-side partial-cut.

9. The underwear of claim 1,
wherein an entirety of said underwear consists exclusively of a single, seam-less, elastic-free, tubular knitted-yarn fabric cylinder, having a front-side cut and a rear-side cut that together define two leg openings.

10. The underwear of claim 1,
wherein an entirety of said underwear consists exclusively of:
(i) a single, seam-less, elastic-free, tubular knitted-yarn fabric cylinder, having a front-side cut and a rear-side cut that together define two leg openings, and
(ii) a lace band that is seamlessly attached to a knitted-yarn waist-region of said underwear, via a seam-less connection.

11. The underwear of claim 1,
wherein a right-leg covering portion of said underwear, is a first closed band of said single knitted tubular fabric blank;
wherein a left-leg covering portion of said underwear, is a second, opposite, closed band of said single knitted tubular fabric blank.

12. The underwear of claim 11,
wherein the right-leg covering portion of said underwear has a gradually-changing width that directly corresponds to a gradually-changing width of the first closed band of said single knitted tubular fabric blank;
wherein the left-leg covering portion of said underwear has a gradually-changing width that directly corresponds to a gradually-changing width of the second closed band of said single knitted tubular fabric blank.

13. The underwear of claim 1,
wherein (i) the seamless knitted-yarn right-side aperture structure, and (ii) the seamless knitted-yarn top-side aperture structure, and (iii) the seamless knitted-yarn front-side fabric-region, and (iv) the seamless knitted-yarn rear-side fabric-region, and (v) the seamless knitted-yarn gusset fabric-region, are all a first knitted-yarn seam-less band of said single knitted tubular fabric blank;
wherein (I) the seamless knitted-yarn left-side aperture structure, and (ii) the seamless knitted-yarn top-side aperture structure, and (iii) the seamless knitted-yarn front-side fabric-region, and (iv) the seamless knitted-yarn rear-side fabric-region, and (v) the seamless knitted-yarn gusset fabric-region, are all a second, opposite, knitted-yarn seam-less band of said single knitted tubular fabric blank.

14. The underwear of claim 1,
wherein an entirety of said underwear consists exclusively of a single tubular knitted-yarn fabric cylinder, which has (I) a first seam-less circular knitted-yarn band, and (II) a second generally-parallel seam-less circular knitted-yarn band, and (III) a tubular seam-less knitted-yarn fabric that has a generally-rectangular structure when laid flat and that connects the first seam-less circular knitted-yarn band and the second seam-less circular knitted-yarn band;
wherein the first seam-less circular knitted-yarn band is generally perpendicular to a ground when the underwear is worn by the human wearer;
wherein the second seam-less circular knitted-yarn band is generally perpendicular to the ground when the underwear is worn by the human wearer.

15. The underwear of claim 1,
wherein an entirety of said underwear is elastic-free, and excludes any elastic band that encircles the waists of the human wearer, and excludes any elastic band that encircles any leg opening of said underwear.

16. The underwear of claim 1,
wherein said underwear is formed of at least one of:
cotton, polyester, natural yarn, synthetic yarn, a blend of natural yarn and synthetic yarn.

17. A method comprising:
manufacturing an underwear for a human wearer, by performing:
(a) knitting a single, seamless, tubular, knitted-yarn blank;
(b) cutting a front-side partial-cut at a front-side of the single seamless tubular knitted-yarn blank; and cutting a rear-side partial-cut at a rear-side of said single seamless tubular knitted-yarn blank;
wherein the cutting of the front-side partial-cut comprises: cutting a front-side cut line that penetrates, from a first knitted-yarn edge of said single seamless knitted tubular knitted-yarn blank, inwardly across a front-side ply of knitted fabric towards a second, opposite, knitted-yarn edge of said single seamless knitted tubular knitted-yarn blank, without reaching said second knitted-yarn edge of said single seamless knitted tubular knitted-yarn blank;
wherein the cutting of the rear-side partial-cut comprises: cutting a rear-side cut line that penetrates, from the first knitted-yarn edge of said single seamless knitted tubular knitted-yarn blank, inwardly across a rear-side ply of knitted fabric towards a second, opposite, knitted-yarn edge of said single seamless knitted tubular knitted-yarn blank, without reaching said second knitted-yarn edge of said single seamless knitted tubular knitted-yarn blank;
(c) seamlessly attaching an elastic-free lace band to fabric regions that border said front-side cut line and said front-side cut line, to form a waist opening of said underwear.

18. The method of claim 17,
wherein the manufacturing excludes, and does not require, any cutting-out and any removal or discarding of any excess knitted fabric.

19. A system comprising:
a manufacturing apparatus to manufacture an underwear for a human wearer, comprising:
(a) a knitting unit configured to knit a single, seamless, tubular, knitted-yarn blank;
(b) a cutting unit, configured to perform a front-side partial-cut at a front-side of the single seamless tubular knitted-yarn blank; and also configured to perform rear-side partial-cut at a rear-side of said single seamless tubular knitted-yarn blank;
wherein the cutting unit is configured to perform a front-side cut line that penetrates, from a first knitted-yarn edge of said single seamless knitted tubular knitted-yarn blank, inwardly across a front-side ply of knitted fabric towards a second, opposite, knitted-yarn edge of said single seamless knitted tubular knitted-yarn blank, without reaching said second knitted-yarn edge of said single seamless knitted tubular knitted-yarn blank;
wherein the cutting unit is configured to perform a rear-side cut line that penetrates, from the first knitted-yarn edge of said single seamless knitted tubular knitted-yarn blank, inwardly across a rear-side ply of knitted fabric towards a second, opposite, knitted-yarn edge of said single seamless knitted tubular knitted-yarn blank, without reaching said second knitted-yarn edge of said single seamless knitted tubular knitted-yarn blank;
(c) a seamless bonding unit, configured to seamlessly attach an elastic-free lace band to fabric regions that border said front-side cut line and said front-side cut line, to form a waist opening of said underwear.

20. The system of claim 19,
wherein the manufacturing apparatus is configured to manufacture said underwear without performing and without requiring,
any cutting-out and any removal and any discarding of any excess knitted fabric.
